(19) United States
(12) Patent Application Publication
(10) Pub. No.: US 2016/0342263 A1
(43) Pub. Date: Nov. 24, 2016

(54) ELECTRONIC DEVICE AND METHOD FOR CONTROLLING DISPLAY OF NOTIFICATION INTERFACE

(71) Applicant: FIH (HONG KONG) LIMITED, Kowloon (HK)

(72) Inventor: WANG-HUNG YEH, New Taipei (TW)

(21) Appl. No.: 14/796,561

(22) Filed: Jul. 10, 2015

(30) Foreign Application Priority Data
May 22, 2015 (TW) 104116583

(51) Int. Cl. G06F 3/041; G06F 3/0488

(52) U.S. Cl. CPC G06F 3/0416; G06F 3/0488

(57) ABSTRACT

A method for controlling display of a notification interface of an electronic device, the electronic device includes a touch screen to detect touch operations. When the touch screen detects a sliding operation sliding along a predetermined direction, at least a portion of the notification interface is displayed on the touch screen. During sliding of the sliding operation, a display area of the notification interface displayed on the touch screen is adjusted in real time according a change of a distance of a track of the first sliding operation. When the first sliding operation is terminated and the distance of the track is less than a predetermined distance, the notification interface includes a first portion which is displayed on the touch screen and a second portion which is not displayed on the touch screen.

### CROSS-REFERENCE TO RELATED APPLICATIONS

This application claims priority to Taiwanese Patent Application No. 104116583 filed on May 22, 2015, the contents of which are incorporated by reference herein.

### FIELD

The subject matter herein generally relates to an electronic device and a method for controlling display of a notification interface of the electronic device.

### BACKGROUND

Electronic devices, such as laptop computers, smart phones, and personal digital assistants (PDAs), are becoming more and more popular. A plurality of customized applications (APPs) can be selectively installed in the electronic devices according to different user requirements. When an APP receives a new event notification, the electronic device can notify the user of the received new event using a notification interface. Generally, the notification interface can show different new event notifications received by different APPs and can be displayed on a display of the electronic device according to operations (e.g., touch operations) of the user.

### BRIEF DESCRIPTION OF THE DRAWINGS

Implementations of the present technology will now be described, by way of example only, with reference to the attached figures.

FIG. 1 illustrates a block diagram of an example embodiment of an electronic device.

FIG. 2 illustrates a portion of a notification interface of the electronic device is displayed on a touch screen of the electronic device of FIG. 1.

FIG. 3 illustrates a display area of the notification interface gradually increases accompanying sliding of a first sliding operation.

FIG. 4 illustrates the notification interface is entirely displayed on the touch screen in full screen.

FIG. 5 illustrates a flowchart of a method for controlling display of the notification interface of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising”, when utilized, means “including, but not necessarily limited to”; it specifically indicates open-ended inclusion or membership in the so-described combination, group, series and the like.

The present disclosure is described in relation to an electronic device and a method for controlling display of a notification interface of the electronic device.

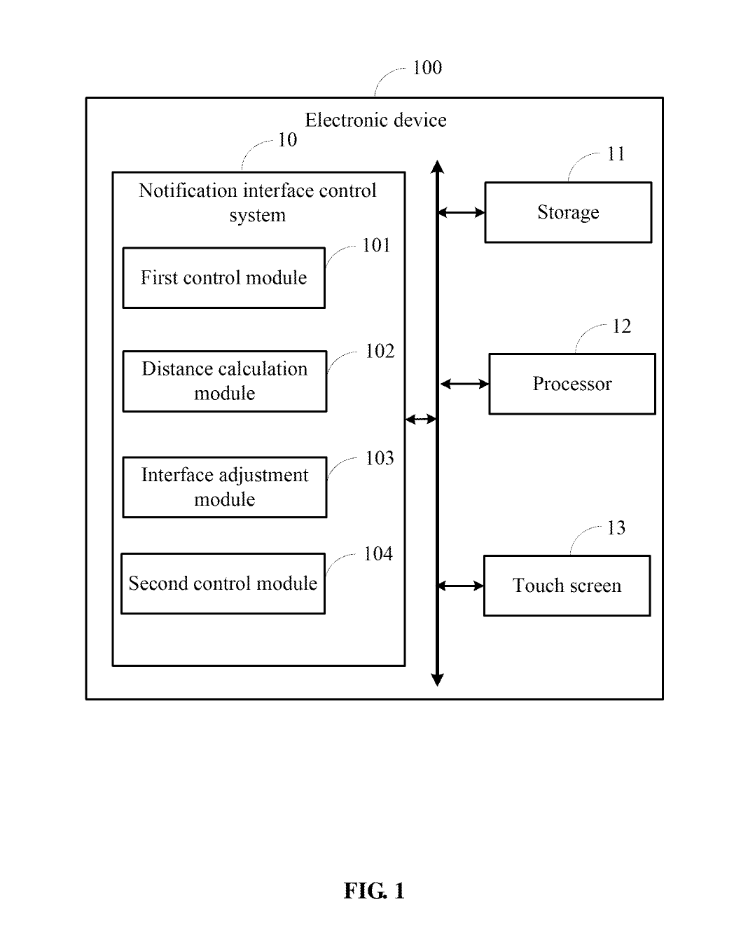

FIG. 1 illustrates a block diagram of an example embodiment of an electronic device 100. In at least one embodiment as shown in FIG. 1, the electronic device 100 can include, but is not limited to, a notification interface control system 10, a storage 11, a processor 12, and a touch screen 13 FIG. 1 illustrates only one example of the electronic device 100, other examples can comprise more or fewer components than those shown in the embodiment, or have a different configuration of the various components.

The processor 12 executes one or more computerized codes and other applications of the electronic device 100 to provide functions of the electronic device 100. The storage 11 can be a non-transitory computer-readable medium and can be an internal storage device, such as a random access memory (RAM) for temporary storage of information, and/or a read only memory (ROM) for permanent storage of information. The storage 11 can also be an external storage device, such as an external hard disk, a storage card, or a data storage medium.

In at least one embodiment, the notification interface control system 10 can include, but is not limited to, a first control module 101, a distance calculation module 102, an interface adjustment module 103, and a second control module 104. The above mentioned modules 101-104 can include computerized instructions in the form of one or more computer-readable programs that can be stored in a non-transitory computer-readable medium, such as the storage 11, and be executed by the processor 12 of the electronic device 100. In at least one embodiment, the notification interface control system 10 can control the display of a notification interface of the electronic device 100. In at least one embodiment, a plurality of applications (APPs) can be installed on the electronic device 100. The notification interface can be a graphic user interface (GUI) configured to display a plurality messages associated with the APPs to notify a user of new events received by the APPs. For example, when a new E-mail is received by the electronic device 100, a prompt message of the new E-mail will be displayed on the notification interface. The user can operate the electronic device 100 to display the notification interface on the touch screen 13.

The touch screen 13 can be a resistance touch screen, a capacitance touch screen, an optical touch screen, or a infrared touch screen. The touch screen 13 can display different graphic user interfaces of the electronic device 100. Further, the touch screen 13 can detect different touch operations, such as single touch operation, multi-touch operations, or sliding operations, applied on the touch screen 13.

The first control module 101 controls at least a portion of the notification interface of the electronic device 100 to be displayed on the touch screen 13 when a first sliding operation is detected by the touch screen 13.

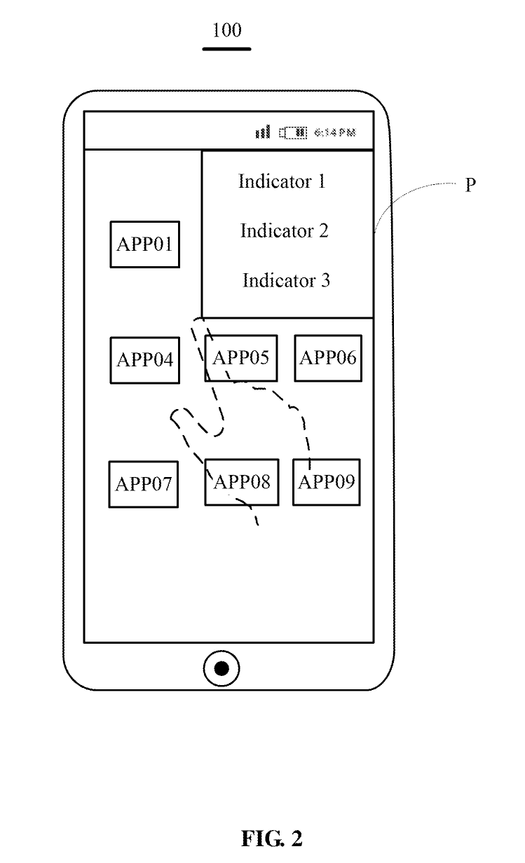

In at least one embodiment, the first sliding operation refers to a touch operation which slides a long a first predetermined direction starting from a first predetermined area of the touch screen 13. For example, the first sliding operation can slide from a top right corner to a bottom left corner of the touch screen 13. As shown in FIG. 2, when a user slides his/her finger from the top right corner to the bottom left corner of the touch screen 13, a notification interface P is gradually pulled out from the up right corner of the touch screen 13, and a portion of content of the notification interface P is displayed on the touch screen 13. For example, “indicator 1”, “indicator 2”, and “indicator 3” are displayed on the touch screen 13.

The distance calculation module 102 obtains a track of the first sliding operation and calculates a distance of the track of the first sliding operation in real time. In at least one embodiment, the distance of the track of the first sliding operation can be a straight-line distance between a starting point of the track and an extreme point of the track. The extreme point of the track may be changed if the first sliding operation is not terminated.

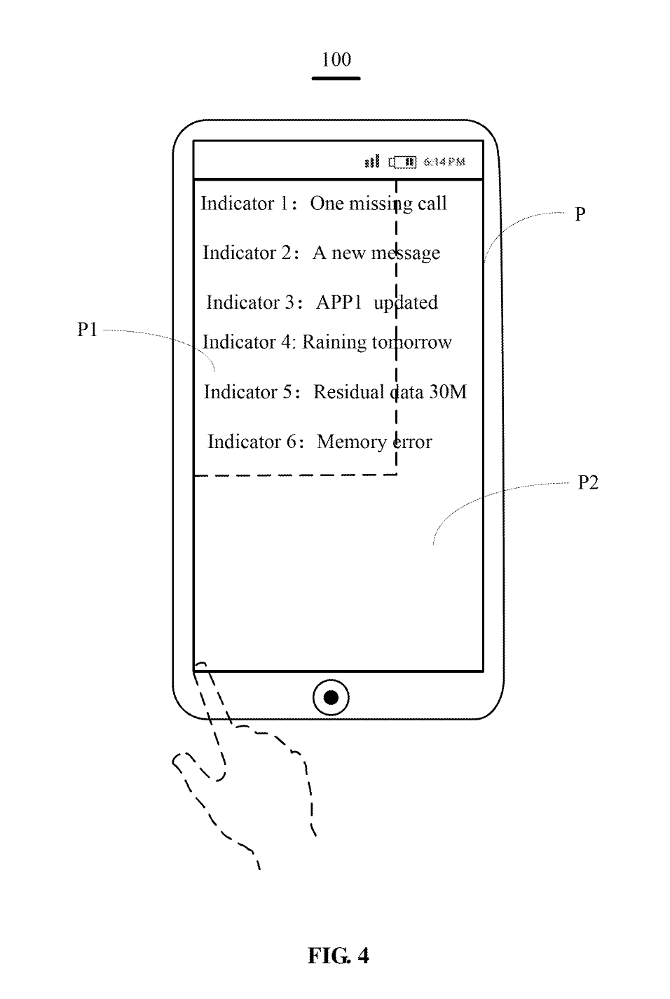

The interface adjustment module 103 adjusts a display area of the notification interface on the touch screen 13 during sliding of the first sliding operation according a change of the distance of the track of the first sliding operation. In at least one embodiment, if the distance of the track is less than a predetermined distance when the first sliding operation is terminated, the notification interface is divided into a first portion which is displayed on the touch screen 13 and a second portion which is not displayed on the touch screen 13. At this time, the touch screen 13 is divided into a first display region which is taken up by the first portion of the notification interface and a second display region which is not taken up by the first portion of the notification interface. For example, as shown in FIG. 4, when the first sliding operation is terminated, only a first portion P1 of the notification interface P is displayed on the touch screen 13, while a second portion P2 (see FIG. 4) of the notification P is not displayed on the touch screen 13. In this embodiment, the first sliding operation is terminated refers to that the first sliding operation disappears from the touch screen 13 and the touch screen 13 can not detect the touch of the first sliding operation any longer.

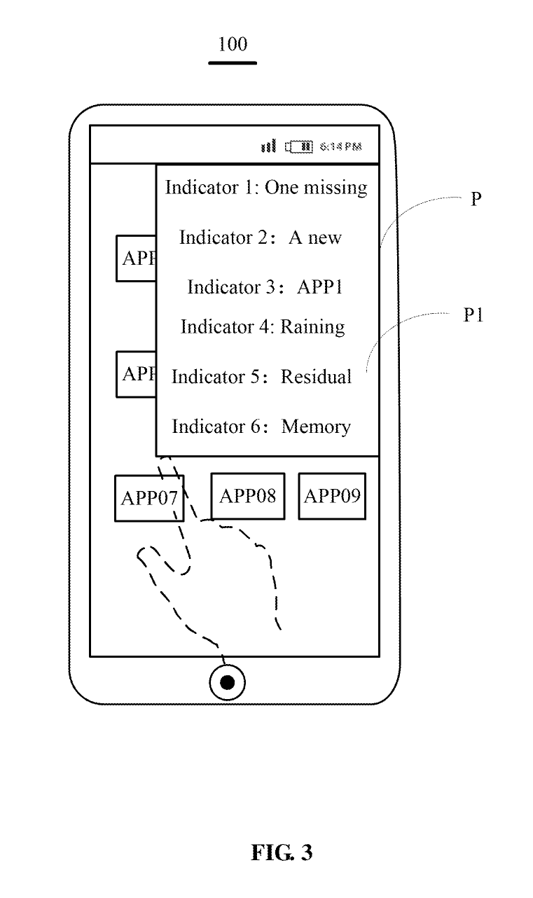

In this embodiment, the predetermined distance is less than or equal to a distance between the up right corner and the bottom left corner of the touch screen 13. The display area of the notification interface on the touch screen 13 refers to a portion of the notification interface which is displayed on the touch screen 13. The display area gradually increases as the distance of the track is increased. Accordingly, the display area gradually decreases as the distance of the track is decreased. For example, as shown in FIG. 3, when the first sliding operation continues to slide from a position of FIG. 2 to the bottom left corner of the touch screen 13, the display area of the notification interface gradually increases and more and more information of the notification interface is displayed on the touch screen 13.

When the distance of the track of the first sliding operation reaches or exceeds the predetermined distance, the interface adjustment module 103 controls the notification interface to be entirely displayed on the touch screen 13 in full screen. For example, as shown in FIG. 4, when the first sliding operation slides to the bottom left corner of the touch screen 13 from the position of FIG. 3, the notification interface P is completely displayed on the touch screen 13 in full screen. FIG. 0.4 shows that the first portion P1 which is displayed on the touch screen 13 of FIG. 3 and the second portion P2 which is not displayed on the touch screen 13 of FIG. 3 both are displayed on the touch screen 13.

The second control module 104 hides the notification interface displayed on the touch screen 13 and controls the touch screen 13 to display a previous image which is displayed on the touch screen 13 before notification interface, when a second sliding operation is detected by the touch screen 13. The second sliding operation refers to a touch operation which slides a long a second predetermined direction starting from a second predetermined area of the touch screen 13. For example, the second sliding operation can slide from the bottom left corner to the up right corner of the touch screen 13. In at least one embodiment, the first predetermined direction is reverse to the second predetermined direction. The second sliding operation is performed after the first sliding operation has been terminated.

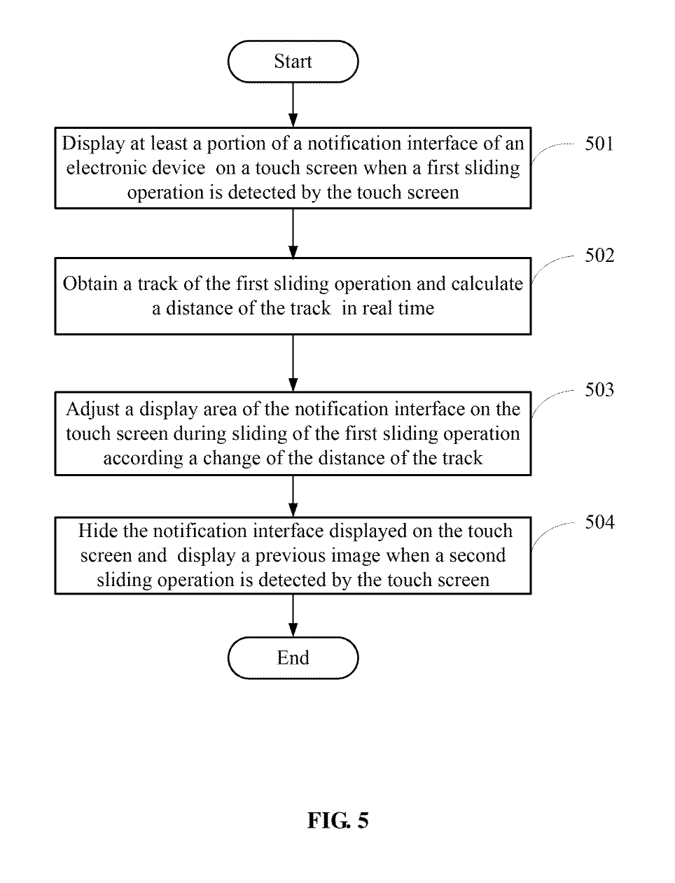

FIG. 5 illustrates a flowchart of a method for controlling display of the notification interface of the electronic device 100 of FIG. 1. The method is provided by way of example, as there are a variety of ways to carry out the method. Each block shown in FIG. 5 represents one or more processes, methods, or subroutines which are carried out in the example method. Furthermore, the order of blocks is illustrative only and the order of the blocks can change. Additional blocks can be added or fewer blocks may be utilized without departing from the scope of this disclosure. The example method can begin at block 501.

At block 501, at least a portion of a notification interface of the electronic device 100 is displayed on a touch screen 13 using a first control module 101, when a first sliding operation is detected by the touch screen 13.

At block 502, a track of the first sliding operation is obtained and a distance of the track of the first sliding operation is calculated in real time using a distance calculation module 102.

At block 503, a display area of the notification interface on the touch screen 13 is adjusted during sliding of the first sliding operation according a change of the distance of the track using an interface adjustment module 103. At least one embodiment, if the distance of the track is less than a predetermined distance when the first sliding operation is terminated, the notification interface is divided into a first portion which is displayed on the touch screen 13 and a second portion which is not displayed on the touch screen 13. At this time, the touch screen 13 is divided into a first display region which is taken up by the first portion of the notification interface and a second display region which is not taken up by the first portion of the notification interface

At block 504, the notification interface displayed on the touch screen 13 is hidden and the touch screen 13 is controlled to display a previous image which is displayed on the touch screen 13 before notification interface using a second control module 104, when a second sliding operation is detected by the touch screen 13. The second sliding operation is performed after the first sliding operation has been terminated.

As described above, the notification interface of the electronic device 100 can be selectively partially displayed on the touch screen 13 according different sliding operations, thereby satisfying different user requirements.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a touch screen;
a processor; and
a storage that stores one or more programs executed by the processor, the one or more programs comprising:
a first control module controlling at least a portion of a notification interface of the electronic device to be displayed on the touch screen when a first sliding operation is detected by the touch screen; and
an interface adjustment module adjusting a display area of the notification interface on the touch screen during sliding of the first sliding operation according a change of a distance of a track of the first sliding operation;
wherein when the first sliding operation is terminated and the distance of the track is less than a predetermined distance, the notification interface comprises a first portion which is displayed on the touch screen and a second portion which is not displayed on the touch screen.

2. The electronic device according to claim 1, wherein when the first sliding operation is terminated and the distance of the track is less than a predetermined distance, the touch screen comprises a first display region which is taken up by the first portion of the notification interface and a second display region which is not taken up by the first portion.

3. The electronic device according to claim 1, wherein the first sliding operation is a touch operation which slides a long a first predetermined direction starting from a first predetermined area of the touch screen; the distance of the track of the first sliding operation is a straight-line distance between a starting point of the track and an extreme point of the track.

4. The electronic device according to claim 1, wherein the display area of the notification interface displayed on the touch screen increases as the distance of the track is increased, and the display area decreases as the distance of the track is decreased.

5. The electronic device according to claim 1, wherein when the distance of the track of the first sliding operation reaches or exceeds the predetermined distance, the interface adjustment module controls the notification interface to be entirely displayed on the touch screen in full screen.

6. The electronic device according to claim 1, wherein the one or more programs further comprise:
a second control module hiding the notification interface displayed on the touch screen and controlling the touch screen to display a previous image which is displayed on the touch screen before notification interface, when a second sliding operation is detected by the touch screen.

7. The electronic device according to claim 6, wherein the second sliding operation is a touch operation which slides a long a second predetermined direction starting from a second predetermined area of the touch screen.

8. The electronic device according to claim 1, wherein the one or more programs further comprises:
a distance calculation module obtaining the track of the first sliding operation and calculating the distance of the track of the first sliding operation in real time.

9. A method for controlling display of a notification interface of an electronic device having a touch screen, the method comprising:
controlling at least a portion of the notification interface of the electronic device to be displayed on the touch screen when a first sliding operation is detected by the touch screen; and
adjusting a display area of the notification interface on the touch screen during sliding of the first sliding operation according a change of a distance of a track of the first sliding operation;
wherein when the first sliding operation is terminated and the distance of the track is less than a predetermined distance, the notification interface comprises a first portion which is displayed on the touch screen and a second portion which is not displayed on the touch screen.

10. The method according to claim 9, wherein when the first sliding operation is terminated and the distance of the track is less than a predetermined distance, the touch screen comprises a first display region which is taken up by the first portion of the notification interface and a second display region which is not taken up by the first portion.

11. The method according to claim 9, wherein the first sliding operation is a touch operation which slides a long a first predetermined direction starting from a first predetermined area of the touch screen; the distance of the track of the first sliding operation is a straight-line distance between a starting point of the track and an extreme point of the track.

12. The method according to claim 9, wherein the display area of the notification interface displayed on the touch screen increases as the distance of the track is increased, and the display area decreases as the distance of the track is decreased.

13. The method according to claim 9, wherein when the distance of the track of the first sliding operation reaches or exceeds the predetermined distance, the notification interface is entirely displayed on the touch screen in full screen.

14. The method according to claim 9, further comprising:
hiding the notification interface displayed on the touch screen and controlling the touch screen to display a previous image which is displayed on the touch screen before notification interface, when a second sliding operation is detected by the touch screen.

15. The method according to claim 14, wherein the second sliding operation is a touch operation which slides a long a second predetermined direction starting from a second predetermined area of the touch screen.

16. The method according to claim 9, further comprising:
obtaining the track of the first sliding operation and calculating the distance of the track of the first sliding operation in real time.
